(19) United States
(12) Patent Application Publication
(10) Pub. No.: US 2024/0217549 A1
(43) Pub. Date: Jul. 4, 2024

(54) FORWARD SIMULATION FOR DECISION-MAKING FOR DEVICE OPERATION

(71) Applicant: QUALCOMM Incorporated, San Diego, CA (US)

(72) Inventors: Paul Daniel MARTIN, Devon, PA (US); Pranav DESAI, San Diego, CA (US); Stephen Marc CHAVES, Philadelphia, PA (US)

(21) Appl. No.: 18/529,417

(22) Filed: Dec. 5, 2023

Related U.S. Application Data
(60) Provisional application No. 63/477,797, filed on Dec. 29, 2022.

(51) Int. Cl. B60W 60/00; B60W 40/04; G06N 7/01

(52) U.S. Cl. CPC B60W 60/0011; B60W 40/04; B60W 60/00274; G06N 7/01; B60W 2554/4041; B60W 2554/4045

(57) ABSTRACT

Disclosed are systems, apparatuses, processes, and computer-readable media for a lightweight forward simulation for decision-making. For example, a computing device for decision making for operation of at least one vehicle can determine a plurality of prediction trajectories onto a path of a vehicle within a simulated scene over time at time steps. Each prediction trajectory of the plurality of prediction trajectories can include at least one position of the vehicle or at least one location of an agent vehicle of one or more agent vehicles that changes as a function of time. The computing device can further determine one or more reactions of the one or more agent vehicles based on at least the position of the vehicle and each respective reactivity model assigned to each agent vehicle. For example, a respective reactivity model can be based on a traffic context.

### CROSS-REFERENCE TO RELATED APPLICATIONS

This application claims priority to U.S. Provisional Patent Application No. 63/477,797, filed Dec. 29, 2022, which is hereby incorporated by reference, in its entirety and for all purposes.

### FIELD OF THE DISCLOSURE

The present disclosure generally relates to decision making for operation of devices. For example, aspects of the present disclosure include systems and techniques for providing a lightweight forward simulation for decision-making for operation of devices (e.g., for vehicles, such as autonomous vehicles, semi-autonomous vehicles, or other types of vehicles).

### BACKGROUND OF THE DISCLOSURE

Decision-making frameworks, such as a Monte Carlo tree search (MCTS) decision-making framework, are commonly used throughout various technological fields, including robotics, artificial intelligence (AI)/machine learning, among other fields. For instance, MCTS operates by modeling the problem (or game), forward-simulating the model to estimate how actions might affect the world (or game), and building a tree of action decisions to search a space of possibilities. Rewards are gathered along the forward-simulated routes through the tree to build up knowledge of which actions are beneficial to solve the problem (or win the game). MCTS is unique in that it uses a mechanism to decide when to explore new action spaces or when to exploit actions that have previously proven to be beneficial. There is a need for an improved technique for decision making using MCTS with a reduction in needed computation time.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for decision making (e.g., for autonomous vehicles, semi-autonomous vehicles, or other types of vehicles or objects that perform decision-making tasks). According to at least one illustrative example, a method decision making for operation of at least one vehicle is provided. The method includes: determining, by a computing device, a plurality of prediction trajectories relative to a path of a vehicle within a simulated scene over time at time steps, wherein cach prediction trajectory of the plurality of prediction trajectories comprises at least one location of an agent vehicle of one or more agent vehicles that change as a function of time; and determining, by the computing device, one or more reactions of the one or more agent vehicles based on at least one future position of the vehicle and each respective reactivity model, associated with a respective traffic context, assigned to each agent vehicle; and determining, by the computing device, one or more prediction paths for the vehicle within the simulated scene based on the determined one or more reactions.

In another illustrative example, an apparatus for decision making for operation of at least one vehicle is provided. The apparatus includes at least one memory and at least one processor coupled to the at least one memory. The at least one processor is configured to: determine a plurality of prediction trajectories relative to a path of a vehicle within a simulated scene over time at time steps, wherein each prediction trajectory of the plurality of prediction trajectories comprises at least one location of an agent vehicle of one or more agent vehicles that change as a function of time; determine one or more reactions of the one or more agent vehicles based on at least one future position of the vehicle and each respective reactivity model, associated with a respective traffic context, assigned to cach agent vehicle; and determine one or more prediction paths for the vehicle within the simulated scene based on the determined one or more reactions.

In another illustrative example, a non-transitory computer-readable medium is provided that includes instructions that, when executed by at least one processor, cause the at least one processor to: determine a plurality of prediction trajectories relative to a path of a vehicle within a simulated scene over time at time steps, wherein cach prediction trajectory of the plurality of prediction trajectories comprises at least one location of an agent vehicle of one or more agent vehicles as a function of time; determine one or more reactions of the one or more agent vehicles based on at least one future position of the vehicle and each respective reactivity model, associated with a respective traffic context, assigned to each agent vehicle; and determine one or more prediction paths for the vehicle within the simulated scene based on the determined one or more reactions.

In another illustrative example, an apparatus for decision making for operation of at least one vehicle is provided. The apparatus includes: means for determining a plurality of prediction trajectories relative to a path of a vehicle within a simulated scene over time at time steps, wherein cach prediction trajectory of the plurality of prediction trajectories comprises at least one location of an agent vehicle of one or more agent vehicles as a function of time; means for determining one or more reactions of the one or more agent vehicles based on at least one future position of the vehicle and cach respective reactivity model, associated with a respective traffic context, assigned to each agent vehicle; and means for determining one or more prediction paths for the vehicle within the simulated scene based on the determined one or more reactions.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

In some aspects, the computing device and/or apparatus is, is part of, and/or includes a vehicle or a computing device or component of a vehicle (e.g., an autonomous vehicle, semi-autonomous vehicles, or other types of vehicles), a robotics device or system or a computing device or component of a robotics device or system, a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, a camera, or other device. In some aspects, the computing device, apparatuses, and/or vehicle includes a camera or multiple cameras for capturing one or more images. In some aspects, the computing device, apparatuses, and/or vehicle further includes a display for displaying one or more images, notifications, and/or other displayable data. In some aspects, the computing device, apparatuses, and/or vehicle described above can include one or more sensors (e.g., one or more inertial measurement units (IMUs), such as one or more gyrometers, one or more accelerometers, any combination thereof, and/or other sensor).

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and cach claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is an image illustrating an example of a road including static objects and a vehicle driving on the road, in accordance with some aspects of the present disclosure.

FIG. 2 is a diagram illustrating an example of a high level process for maneuvers for a vehicle, in accordance with some aspects of the present disclosure.

FIG. 3 are graphs illustrating examples of reference paths for an AV, in accordance with some aspects of the present disclosure.

FIG. 4 is a diagram illustrating an example of a process for a Monte Carlo Tree Search (MCTS), in accordance with some aspects of the present disclosure.

FIG. 5 is a diagram illustrating a system for performing a lightweight forward simulation for decision-making, in accordance with some aspects of the present disclosure.

FIG. 6 are diagrams illustrating example of forward simulation for traffic including an AV, in accordance with some aspects of the present disclosure.

FIG. 7 is a flow chart illustrating an example of a process for a lightweight forward simulation for decision-making, in accordance with some aspects of the present disclosure.

FIG. 8 is a block diagram illustrating an example of a computing system, which may be employed by the disclosed systems and techniques for a lightweight forward simulation for decision-making, in accordance with some aspects of the present disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

As previously mentioned, decision-making frameworks (also referred to as planning algorithms) are commonly used throughout various technology fields, such as robotics, artificial intelligence (AI), etc. One example of a decision-making framework is Monte Carlo tree search (MCTS). MCTS operates by modeling a problem (e.g., a game), forward-simulating the model to estimate how actions might affect the world (e.g., the game), and building a tree of action decisions to search a space of possibilities. Rewards are gathered along the forward-simulated routes through the tree to build up knowledge of which actions are beneficial to solve the problem (e.g., win the game). MCTS is unique in that it uses a mechanism to decide when to explore new action spaces or when to exploit actions that have previously proven to be beneficial.

Runtime can be an important consideration for how to design and deploy MCTS. For example, MCTS is one framework that can be applied to make decisions in vehicles (e.g., autonomous vehicles AVs, semi-autonomous vehicles, etc.), such as for decisions that require searching over a long planning horizon in complex environments. However, because the space of possibilities can grow intractably with the number of available actions and depth of search, vehicles can require real-time operation in order to make safe and comfortable decisions quickly.

Efficiently pruning the search space can be one approach that can help to reduce computation time. Such a pruning approach can require a careful and smart strategy for a explore and exploit tradeoff. Another approach to reduce runtime can be to approximate different aspects of the forward simulation through deep learning techniques. Deep reinforcement learning is an active area of research that can directly benefit the design of MCTS. The more complexity that may exist in a problem, the more need there may be for an extensive search (e.g., both in breadth and depth) and, thus, the greater the emphasis on reducing the computational burden.

Systems, apparatuses, processes (also referred to as methods), and computer-readable media (collectively referred to as “systems and techniques”) are described herein that provide a lightweight forward simulation for decision-making. For example, the systems and techniques provide an approach for using a decision-making frameworks (or planning algorithms), such as MCTS, for decision making (e.g., for AVs, semi-autonomous vehicles, or other devices or systems that perform decision-making tasks), while allowing for a reduction in computational burden. While examples are described herein with respect to autonomous vehicles for illustrative purposes, the systems and techniques can be applied for other types of objects that perform decision-making tasks, such as semi-autonomous vehicles, robotics devices or systems, and/or or objects.

The above-described approach for reducing computational burden in decision-making frameworks (e.g., MCTS or other planning algorithms) for devices or systems (e.g., AVs, etc.) can include a design for a lightweight forward-simulation engine that can be directly integrated into a decision-making framework (e.g., MCTS). For case of reference, the forward simulation can be referred to herein as “traffic simulation” (Traffic Sim). In one or more aspects, Traffic Sim can be a simple simulator of dynamic objects (e.g., vehicles) along their expected trajectories (e.g., prediction trajectories). For example, traffic Sim can operate by stepping vehicles along their predicted trajectories over time, with steps for all vehicles at time “t” being performed simultaneously. At every timestep, cach vehicle can have an opportunity to apply a longitudinal reaction model to modulate the vehicle's longitudinal step along the vehicle's trajectory. In this way, vehicles can step along their prescribed paths in space (e.g., where their lateral component may be fixed), where their longitudinal dynamics (e.g., how far the vehicle steps, at what speed, acceleration, etc.) at each step are determined by their reaction models.

In one or more examples, a reaction model may be any valid, physical model for changing the dynamics of a vehicle at a timestep. For example, a simple reaction model might be to apply a constant acceleration for the vehicle for the duration of the timestep. A more complex reaction model can be to apply to the vehicle an acceleration that is determined through a type of controller (e.g., a controller that outputs safe accelerations when following behind another vehicle). In some cases, “micro-traffic” models can be used. A micro-traffic model is a model in which a subset of vehicles, pedestrians, and/or other relevant entities in a traffic scenario may react to another subset of traffic entities. For example, a single trailing vehicle may react to a single leader vehicle in a leader-follower micro-traffic model. Currently, there are many micro-traffic models that use simple leader-follower states to determine safe and comfortable accelerations for the follower vehicle to apply (e.g., intelligent driver model (IDM), adaptive cruise control (ACC) controllers, derived from kinematics, etc.). In one or more aspects, Traffic Sim can include a set of vehicles that follow along their prescribed paths, cach avoiding potential collisions with one another by reacting according to safe and comfortable longitudinal driving reaction models. Traffic Sim can be implemented and deployed within a decision-making framework (e.g., MCTS) to provide for specific runtime advantages.

In one or more aspects, Traffic Sim can have a geometrical core, which can be referred to as “fast collision detection” (FCD). FCD can be an efficient method for finding possible collisions (or interactions) between two or more vehicles that have predicted trajectories. Possible interactions between the vehicles can be found by checking (determining) whether the path components of the trajectories (e.g., the lateral components only) of the vehicles overlap (or collide) in a geometric sense. Any location where two trajectories overlap can be determined to be a location where a potential collision is possible. In Traffic Sim, when two vehicles stepping along their trajectories are predicted to arrive at the same place and at the same time, it can be determined that the vehicles may collide with one another at that place and future time. As such, FCD can determine whether the future paths of vehicles may overlap, which can indicate a possible collision between the vehicles. Overlapping future paths of vehicles may simply be referred to as “interactions.”

In one or more examples, finding interactions through FCD can be a first stage of Traffic Sim. For planning future actions for an ego vehicle (e.g., a host AV), an interaction query, with respect to the ego vehicle's desired path along the road, may be performed. This interaction query can result in knowing, up front, all of the possible interactions that the ego vehicle may encounter while traveling along its path (e.g., assuming that the other vehicles follow prescribed paths assigned to them as well, through predictions).

In one or more examples, for Traffic Sim, an up-front calculation may be performed for projecting all of the interacting object's (e.g., vehicle's) paths onto the ego vehicle's desired path. In some cases, the projections may be cached for efficient lookup at a later point in time. The projections can effectively map an arclength (or station) along an object's (e.g., vehicle's) predicted path to a corresponding projected arclength (station) along the ego vehicle's path. These projections allow for Traffic Sim to use an object's (e.g., vehicle's) arclength in its own frame of reference (e.g., station along its path) to compare against an ego vehicle's arclength in the ego vehicle's frame of reference. The interactions and projections can be performed ahead of the forward simulation, and cached for future use. All simulations proceeding from Traffic Sim reference the same shared instance of interactions and projections, making this framework lightweight and efficient with memory.

Traffic Sim can then proceed to perform simulations according to the above description (e.g., stepping vehicles along their trajectories and modulating the size of each step according to a reaction model). Much of the benefit of the up-front calculation can be realized at this stage. Since one shared data structure can maintain the interactions and projections, the forward-simulations themselves can be very small and efficient. A full state, or single belief, of a traffic scene can be stored with only a small number of objects (e.g., vehicle) and ego stations along their respective paths. Branching to create a new belief (e.g., a second belief) from a belief (e.g., a first belief) can be trivial by simply copying the array of stations and maintaining a separate belief (e.g., the second belief) alongside the first belief. The two beliefs (e.g., the first belief and the second belief) can then be tracked independently, and in parallel, by applying different reaction models to each such that their states moving forward start to diverge. Further branching is possible at every timestep.

In one or more examples, for an example of an application of a reaction model to single vehicle existing in a traffic belief, this vehicle can be advanced in time from time “t” to time “t+1” by applying an acceleration that can be determined by a leader-follower relationship. Traffic Sim can efficiently determine leaders and followers (e.g., along a 1-d ego vehicle path) by comparing stations (e.g., arclengths) alone. Since Traffic Sim can be utilized within the context of planning for an ego vehicle, the leader-follower relationships of interest can involve the ego vehicle itself. Traffic Sim can provide a beneficial abstraction for answering this query. The object projections onto the ego vehicle's path can give a clear view at all times of which object (e.g., which vehicle) is located ahead of the ego vehicle along the ego vehicle's path, and which object (e.g., which vehicle) is located behind of the ego vehicle along the ego vehicle's path. Then, the application of a reaction model, that does not collide with the ego vehicle, can be very quick to resolve. After applying all of the reactions, the belief can be tracked at the next timestep (e.g., at time “t+1”) through the updated array of stations.

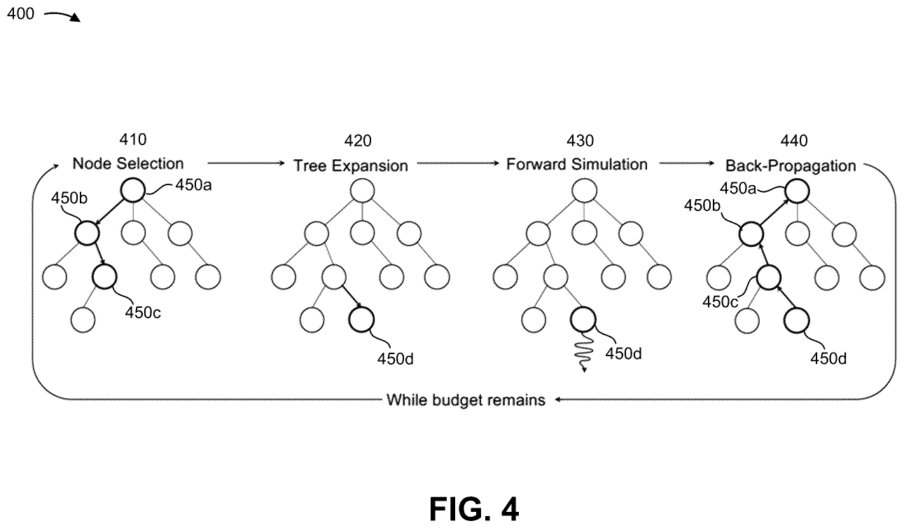

In one or more aspects, MCTS can employ Traffic Sim to encode traffic beliefs throughout the tree (e.g., the MCTS tree, such as shown in FIG. 4). Each node in the tree can represent a unique belief. Creating a child node (e.g., node 450b of FIG. 4) off of a parent node (e.g., a root node, such as root node 450a of FIG. 4) can involve branching the traffic belief, applying a new ego vehicle action and corresponding object (e.g., vehicle) reactions, and caching the new belief at the child node. A further benefit of the Traffic Sim representation is that it can allow for easily gathering rewards (e.g., costs assigned to the longitudinal distance between the ego vehicle and objects, such as vehicles). As used herein, a longitudinal distance and/or lateral distance can be with respect to any reference frame, such as with respect to a Cartesian frame of reference (e.g., a Cartesian grid), a lane-centered Frenet frame, a road-centered Frenet frame, or other frame of reference. Traffic Sim has the advantage of providing a fast, efficient, and parallelizable simulation, which can be advantageous for use in MCTS.

Additional aspects of the present disclosure are described in more detail below.

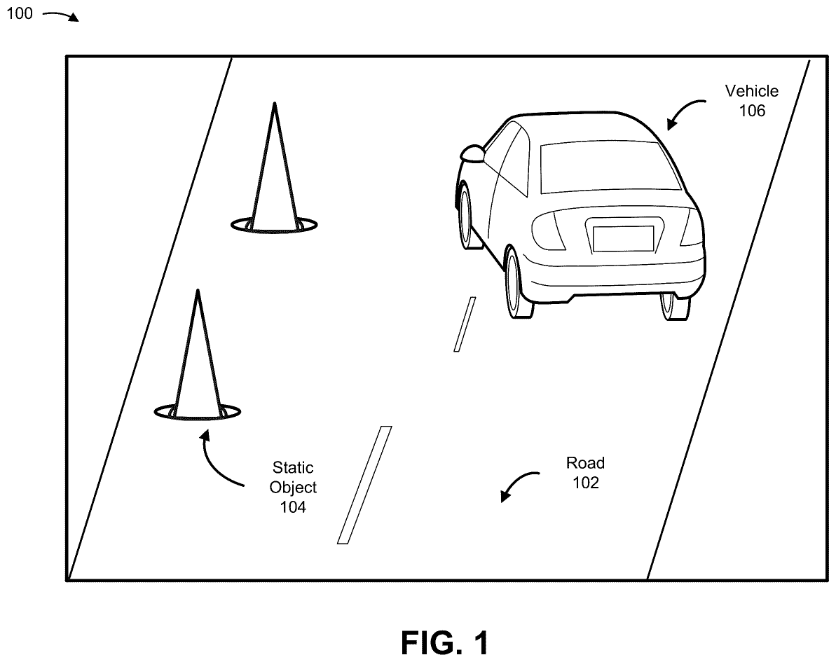

FIG. 1 is an image 100 illustrating a road 102 including static objects (e.g., including static object 104) and a vehicle 106 driving on the road 102. The vehicle 106 is an example of a dynamic object. In some cases, the image 100 can be captured by a tracking vehicle (not shown). The tracking vehicle can be an autonomous vehicle operating at a particular autonomy level. The tracking vehicle can track the vehicle 106 (e.g., a target vehicle) and can attempt to autonomously navigate around the vehicle 106 and the static objects. For example, the tracking vehicle can determine the position (and in some cases the size) of the vehicle 106 and the static object 104. Based on the position of the vehicle 106 and the static object 104, the tracking vehicle can determine when to slow down, speed up, change lanes, and/or perform some other function (e.g., maneuver) in order to avoid a collision with the vehicle 106 and the static object 104.

Other types of systems can also benefit from detecting and/or tracking unexpected objects. For instance, robotics systems that perform operations on objects may need to be able to accurately detect and track unexpected objects. In one illustrative example, a robotics device used for cleaning (e.g., an autonomous vacuum cleaner) may need to be able to detect the presence and location of unexpected objects in an environment in order to avoid such objects when moving throughout the environment. In another illustrative example, a robotics device used for manufacturing may need to know an accurate location of unexpected objects in order to avoid accidents. In another illustrative example, an aviation system (e.g., unmanned aerial vehicles among others) can benefit from an accurate detection of unexpected objects located within a flight path so that the aviation system can accurately navigate around those objects. Many other examples exist of systems that may need to be able to identify the size and position of objects.

As previously mentioned, systems and techniques are described herein that provide a lightweight forward simulation for decision-making. Specifically, the systems and techniques provide an approach for using MCTS for decision making (e.g., for determining maneuvers for AVs), while allowing for a reduction in computational burden. This approach towards reducing computational burden in MCTS (or planning algorithms, in general) for AVs can include a design for a lightweight forward-simulation engine that can be directly integrated into MCTS. As noted previously, this forward simulation can be referred to as “traffic simulation” (Traffic Sim).

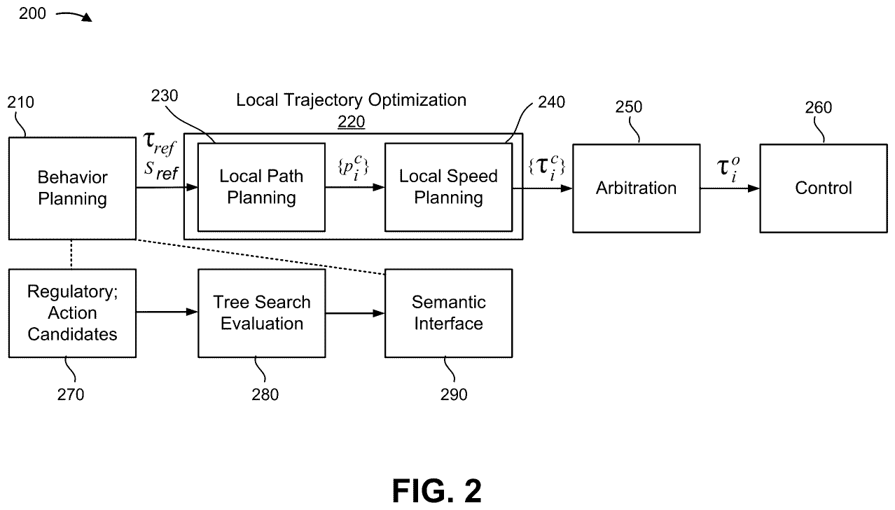

FIG. 2 shows a high-level flow diagram for vehicle planning (e.g., maneuver planning for autonomous vehicles, semi-autonomous vehicles, robotics devices or systems, and/or or objects) that implements the disclosed lightweight forward-simulation engine (e.g., Traffic Sim) for its behavior planning (e.g., which may occur within behavior planning block 210 of FIG. 2). In particular, FIG. 2 is a diagram illustrating an example of a high level process 200 for maneuvers for an autonomous vehicle (AV), which may be referred to as an “ego vehicle.” In one or more examples, a hierarchical planning approach for vehicle planning for autonomous vehicles can be adopted that has a distinction between high level global trajectory optimization (e.g., referred to as behavior planning) and low-level, fine-grained, but local trajectory optimization (e.g., referred to as motion or local planning). The process 200 of FIG. 2 is shown to include a behavior planning block 210, local trajectory optimization 220 (e.g., which can include a local path planning block 230 and a local speed planning block 240), an arbitration block 250 (e.g., for determining an action for the vehicle), and a control block 260 (e.g., for the vehicle to execute the determined action).

The behavior planning block 210 of FIG. 2 can be responsible for general maneuvers and action planning of the vehicle (e.g., autonomous vehicle) as well as for coarse-grained semantic directives to guide a local planner. The behavior planning block 210 can have its execution separated into three logical blocks, which may include a regulatory and action candidate generation block 270, a tree search evaluation block 280 (e.g., using an MCTS), and a semantic extraction and interface block 290 (e.g., utilized for downstream local planning).

In a regulatory and maneuver proposal stage (e.g., in the regulatory and action candidate generation block 270), action candidates may be generated based on a combination of regulatory restrictions, driver input, route guidance, and/or scene understanding. In general, two broad motivations can drive the behavior of the autonomous-vehicle: driver inputs (e.g., which may include desired speeds and/or driver-triggered lane changes) and the progress along a given mission (e.g., making forward progress along a route from start to finish). These drivers can be used to generate a set of desired high level maneuvers (HLMs). These maneuvers can encode a wish-list of actions to aid the autonomous vehicle (e.g., the ego vehicle) in achieving the goals set forth by the driver inputs and/or mission planning. For example, for a simple highway scenario, the autonomous vehicle may be likely to consider HLMs, which may include, but are not limited to, “keep lane,” “change lanes left,” and/or “negotiate for an eventual lane change right.”

However, some of these maneuvers may be illegal or even dangerous. The set of desired maneuvers (e.g., the HLMs) can then be cross-validated against a regulatory layer. The regulatory layer can take into consideration the legal speed limit and intersection signage (e.g., yield signage, stop signage, and/or no turn except right signage), and can restrict the set of maneuvers to those that are law-abiding. For example, at a controlled intersection, accelerating through a red light may help progress the autonomous vehicle along a mission, but that maneuver (e.g., running a red light) is clearly illegal. The resulting set of legal desired maneuvers can comprise a set of “candidate maneuvers.” Evaluating whether a maneuver is legal cannot always be achieved by only using simple logic. Traffic rules, such as right-of-way, must be checked against trajectory planning, collision detection, and forward simulations to ensure that the autonomous vehicle exhibits polite, humanistic, legal driving.

The purpose of the regulatory and action candidate generation block 270 is primarily to provide an abstraction layer for downstream planning. The resulting candidate maneuver set can be evaluated without knowledge of why these maneuvers were generated. In order to perform this evaluation, the maneuvers should be encoded to include a notion of success. This encoding can be primarily useful for lane changes and negotiating tactics in general. For example, a lane change in order to take an exit has a certain deadline for the lane change to occur, after which the lane change may have a reduced utility.

The candidate maneuvers can then be evaluated for safety, comfort, and utility. This evaluation may be performed in two steps. As a first step, an instantaneous, heuristic-based evaluation can prune the candidate maneuvers that will clearly be unsuccessful. For example, a lane change should not be considered if vehicles immediately adjacent to the autonomous vehicle (e.g., ego vehicle) block the lane. As a second step, which can be much more involved, a joint search over path and speed can be performed to determine if any of the candidate maneuvers can be executed in a safe and comfortable manner. This second step can be accomplished by using a tree search (e.g., which may occur within the tree search evaluation block 280 of FIG. 2), such as using MCTS.

In one or more aspects, for each candidate maneuver, a localized search corridor can be generated. For example, a lane-keep maneuver can have a corridor that can include the full lane width, a merge maneuver may have a corridor that encompasses the current lane and some portion of the merging lane, and a lane change maneuver may have a corridor that includes both the original and the destination lane. This localized corridor can allow for a simplification of the action space into one that focuses heavily on longitudinal conflict resolution of the autonomous vehicle (e.g., ego vehicle) through acceleration and braking in order to yield, overtake and, in general, negotiate with nearby traffic. In some examples, this longitudinal conflict resolution can be paired with lateral motion, where computation allows.

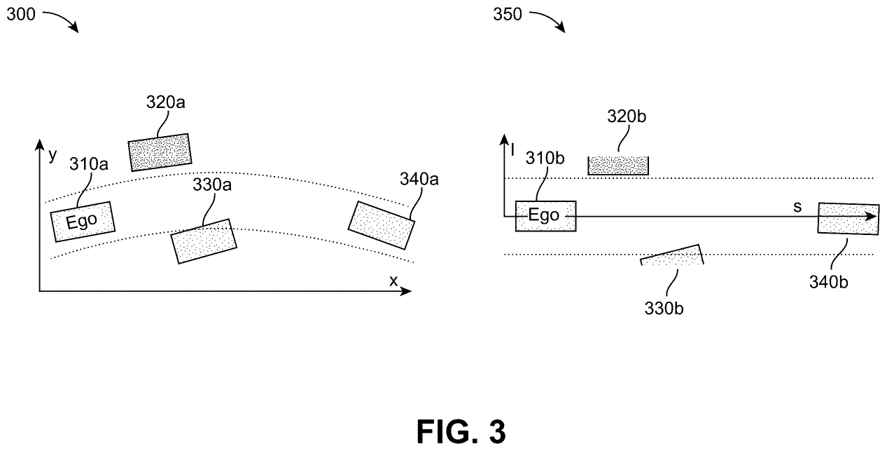

For each localized corridor, a Frenet (path-aligned) reference frame [symbol] ₚ can be defined relative to some nominal path p={p₀, . . . , pₙ₋₁}, p∈ [symbol] ². With respect to [symbol] ₚ, the motion of the autonomous vehicle (e.g., ego vehicle) and surrounding agent vehicles can be described as a combination of station (e.g., distance along the path) and lateral coordinates over time. FIG. 3 shows graphs depicting this Frenet-frame decomposition.

In particular, FIG. 3 are graphs 300, 350 illustrating examples of reference paths for an autonomous vehicle 310a, 310b (e.g., ego vehicle). Specifically, the graphs 300, 350 together illustrate a reduction in dimensionality, which can lead to a reduction in computational burden. Graph 300 depicts an original Euclidian frame (e.g., with an x-axis and y-axis denoting distances) with a curved path for an autonomous vehicle 310a (e.g., ego vehicle). Graph 300 also includes agent vehicles 320a, 330a, 340a driving along the curved path. The autonomous vehicle 310a and the agent vehicles 320a, 330a, 340a may cach be represented by an X, Y coordinate, speed, acceleration, heading, and/or curvature of the path. In graph 300, the autonomous vehicle 310a is shown to be driving along the curved path and appears to be on a course to possibly collide with agent vehicles 330a, 340a, which both appear to be driving within the boundaries of the curved path.

The curved path shown in graph 300 is a non-trivial path for performing calculations to predict future locations of the autonomous vehicle 310a and the agent vehicles 320a, 330a, 340a to determine any possible maneuvers for the autonomous vehicle 310a to perform to avoid any possible future collisions. In graph 350, the curved path is shown to have been converted into (e.g., projected onto) a straight path to reduce dimensionality and complexity for computational purposes.

In particular, in graph 350, the autonomous vehicle 310b and the agent vehicles 320b, 330b, 340b are cach reduced to a single dimension (e.g., one dimension, such as a longitudinal distance along the straight path). This longitudinal distance may be referred to as a “station” or an “arc length.” Graph 350 depicts a Frenet coordinate frame with a Frenet-projected scene of graph 300 that includes a straight path for the autonomous vehicle 310b indexed by station s and lateral offset l. Within the Frenet coordinate frame of graph 350, the agent vehicles 320b, 330b, 340b are shown to be axis aligned in parallel with the straight path of the autonomous vehicle 310b.

In some examples, when computationally permissive, the autonomous vehicle 310b and the agent vehicles 320b, 330b, 340b may each be reduced to two dimensions (e.g., a longitudinal distance along the straight path and a lateral distance). In these examples, these two one-dimensional queries are still very lightweight and simple for computational purposes.

After the localized search corridor has been generated, evaluation of a candidate maneuver within the localized corridor can involve finding a trajectory (e.g., both position and speed over some time horizon) such that the maneuver can be completed safely, comfortably, and within some deadline. The trajectory can be found by performing a MCTS over some planning horizon Tₕ. The goal of MCTS is to expend some computational budget β searching and expanding a belief tree, after which the highest reward traversal of that tree can represent the most desirable future evolution of that maneuver.

MCTS includes decomposition of the “scene” and simulated future “scenes” into discrete nodes. Traversal through this tree can be achieved by actions that evolve one node to another sequentially across some horizon. In one or more examples, a scene S_{F}^{k} at iteration k can be defined as a combination of an autonomous vehicle (e.g., ego vehicle) state tuple {s, l, v, a}_{ego}^{k} and agent vehicle state tuples for an agent vehicle with identifier i, defined as {s, l, v, a, R}ᵢ^{k}. Here, s and l can represent the longitudinal station and lateral deviation with respect to the Frenet reference, v is aligned velocity, a is aligned acceleration, and R is a reaction memory. A simplifying assumption can be made that the occupied space in F for agent i can be determined from the tuple (s, l, R) alone. For the autonomous vehicle (e.g., ego vehicle), such an assumption may not be required, as the occupied Frenet area can be chosen at will. For agent i, this assumption is made possible by assuming a fixed prediction path. If the deviation of an agent from his path in the lateral direction is disallowed, then only the longitudinal modulation of the agent along that path (e.g., speeding up and slowing down in response to neighboring traffic flow) needs to be accounted. This modulation may be achieved by leveraging supplementary information encoded in the reaction memory R. In the simplest sense, this reaction memory can maintain whether an agent vehicle is actively yielding for or overtaking the autonomous vehicle (e.g., ego vehicle) as well as its longitudinal station s relative to its prediction, if a such a reaction has caused a deviation from the original prediction.

The evolution of one node nx to another nₖ₊₁ can be achieved through an action Aₖ. Ignoring lateral actions for the time being, longitudinal actions can be defined in terms of discrete accelerations, spanning a set of reasonably comfortable and feasible values such as A={2,1,0, −1, −2, −3}. Values beyond these actions are atypical and should not be explored until sufficient evidence has been gathered for their necessity. The general flow of MCTS is shown in FIG. 4, where a budget is consumed through the process of node selection 410 via tree policy, tree expansion 420 using action selection, forward simulation 430 using a default policy rollout, and back propagation 440 of simulated rewards. In particular, FIG. 4 is a diagram illustrating an example of a process 400 for a MCTS. In FIG. 4, as shown in node selection 410, a root node 450a can be constructed by extracting autonomous vehicle (e.g., ego vehicle) state information and default reactivity of other agent vehicles based on the predictions. A localized corridor can be provided for the given maneuver class in question (e.g., lane keep, lane change, etc.).

During operation of the process 400 of MCTS, for tree expansion 420, at the start of cach iteration, a TreePolicy function can determine a leaf node (e.g., nodes 450a, 450c, 450d) to expand. This leaf node can be chosen in such a way as to balance exploitation of previous state-value estimates (in the reinforcement sense) and exploration of new actions. Such a balance can be given by the upper confidence bound (UCB). The UCB formula can use an exploration constant c such that if c=0 the “best” child n_{c} of a node n can be that which has the maximum average value, [symbol] (n_{c})/ N(n_{c}) where [symbol] (n_{c}) can be the total reward accumulated at node n. and N(n_{c}) can be the number of visits of the same node. If c=1, the “best” child can be that which maximizes the ratio of parent visits, N(n) and child visits, N(n_{c}), thereby preferring to select infrequently visited children of promising parents. Selecting c∈(0,1) as is generally done can provide some reasonable balance between the two. If a node n has been selected for expansion, some strategy can be used to select a new unexplored action to take n to a new child n′_{c}. This expansion strategy can be a simple random selection from a set of all unexplored actions, a deterministic progression over all unexplored actions, or something more complex.

For forward simulation 430, once a node has been selected, ForwardSimulation is performed conditioned on a “default policy.” Oftentimes this default policy may be a sequence of random actions, until the simulation horizon (e.g., time horizon). In the context of autonomous vehicle (e.g., ego vehicle) speed control, a default policy of zero acceleration or a simple speed control, such as an intelligent driver model (IDM) can be a sensible choice. This simulation can continue for some horizon, after which rewards can be collected and back-propagated (e.g., back propagation 440) according to BackPropagation. The preceding description is a general MCTS approach. When the TreePolicy function is guided by UCB as shown, this MCTS approach is commonly referred to as an Upper Confidence Tree Search, or UCTS. In one or more examples, the MCTS employed by the systems and techniques may be the UCTS variant.

Once the budget has been exhausted, the process 400 for MCTS is complete. The resulting trajectory can be extracted by traversing the tree using the same TreePolicy function, starting at the root node 450a. This can result in a time-varying autonomous vehicle (e.g., ego vehicle) state, as well as the corresponding time-varying reactions of all the agent vehicles in the scene as envisioned by the forward simulation logic. In this sense, MCTS is said to be anytime in that it can be stopped at any given iteration β′≤β, giving a solution to the algorithm MCTS(β′). This can provide a method for scaling computation up and down to match the desired complexity or accuracy of the solution.

There are a number of enhancements that can be made to the general MCTS algorithm, depending on the specifics of any given application. One enhancement for MCTS is progressive backoff (PB). The process of tree expansion and forward simulation can involve repeatedly evaluating future rewards. In many cases, these rewards can come with some uncertainty. In the context of traffic simulation, prediction and behavioral uncertainty can make rewards multiple seconds in the future particularly challenging to evaluate with any real accuracy. One way of incorporating this uncertainty is through PB. PB introduces a backoff term λ∈[0,1] in the back-propagation subroutine in the MCTS algorithm such that rewards are accrued through the equation [symbol] (n)← [symbol] (n)+rλ^{d}^{ₙ}, where dₙ represents the depth of node n, starting with the root at depth 0. The special case of λ=1 effectively disables PB.

Another enhancement for MCTS is progressive widening (PW). The resulting solution “path” from MCTS can be heavily influenced by the number and distribution of action candidates at each node. In its simplest form, nodes at each depth of the search might have a fixed number of identical actions used to generate children. An increased number of actions ∥A∥, however, results in a wider, shallower tree for fixed budget β. For example, a large number of discrete acceleration candidates is searched at each time step, it may not be possible to explore for a large time horizon. One method for searching a large number of candidate actions, while maintaining a deep (long time horizon) tree, is through PW. The idea behind PW is to grow the cardinality of the action set based on how frequently a node has been visited. This allows for action “refinement” for only those nodes that hold the most promise. To do this, an action expansion threshold can be defined as |A(n)|ₘₐₓ=k_{α}N(n)^{α}, where the hyperparameters α∈[0,1] and k_{α}∈ [symbol] ⁺ can determine how “quickly” new actions can be considered as a function of node visits. If |A(n)|<|A(n)|ₘₐₓ, the node can be flagged for action expansion on subsequent visits. Setting α=1 with k_{α}≥1 can effectively disable PW, thereby allowing for a new action at each visit.

Another enhancement for MCTS is temperature. In many scenarios, the most interesting and complex interactions can occur early on in the planning horizon. In this sense, it can be beneficial to take on a more exploratory nature in the early stages, resorting to a more exploitative strategy deeper in the tree. To accomplish this, a temperature parameter τ_{d} can be defined at each depth d, to be used in conjunction with the selection strategy in TreePolicy to guide the explore-exploit tradeoff. In the context of UCTS, this can be thought of as replacing c with ta, thereby allowing depth-specific configurations. In the more traditional sense of temperature, nodes can be re-visited proportional to the quantity N(n)^{1/τ}.

A final enhancement for MCTS is action guidance. PW provides a method for increasing |A(n)| across iterations, but in addition to the cardinality of actions at each node, the nature of these actions can also be influenced based on external data. For example, a slower lead vehicle may ‘guide’ the tree to search for braking speed profiles before it searches for accelerating profiles. In more extreme cases, action guidance may invalidate actions altogether for one or more nodes, taking into consideration forward simulation or any other stimuli.

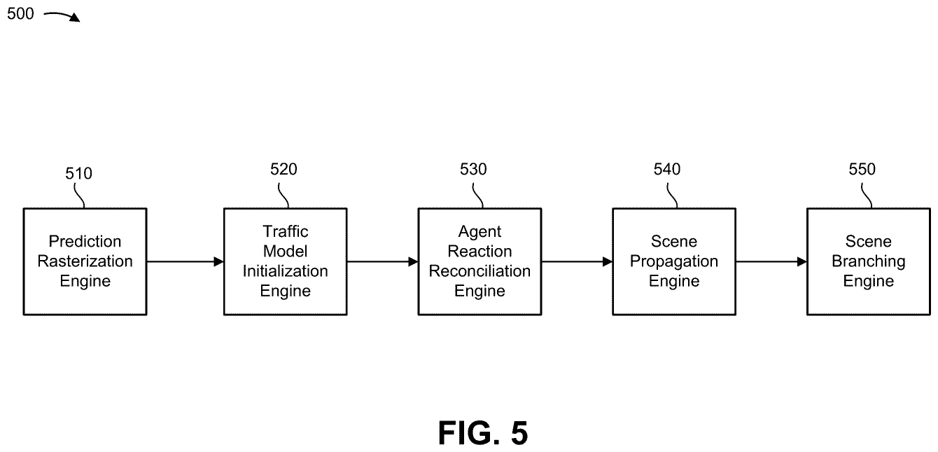

As discussed, MCTS can require a considerable number of forward simulations and evaluations of the resulting scenes. In the context of autonomous driving, this can necessitate an efficient traffic simulator, capable of relational queries, kinematic vehicle propagation, reactivity, and efficient memory structures for branching. FIG. 5 shows a forward simulation strategy for MCTS. In particular, FIG. 5 is a diagram illustrating a system 500 for performing a lightweight forward simulation for decision-making. In FIG. 5 a plurality of engines are shown for the system 500 for forward simulation. Specifically, the engines of the system 500 of FIG. 5 may include a prediction rasterization engine 510, a traffic model initialization engine 520, an agent reaction reconciliation engine 530, a scene propagation engine 540, and a scene branching engine 550.

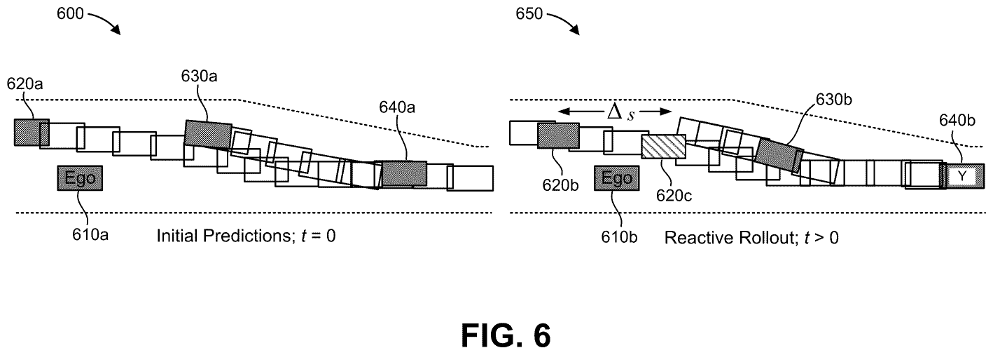

In one or more aspects, during operation of the system 500, the prediction rasterization engine 510 can generate a projection of (e.g., project) predictions (e.g., which can each include a location of an autonomous vehicle or a location of an agent vehicle) across time (e.g., at fixed time steps) relative to (e.g., onto or near) a path (e.g., a localized corridor, such as the straight path of graph 350 of FIG. 3) of the autonomous vehicle (e.g., ego vehicle) within a simulated scene (e.g., diagram 600 of FIG. 6). Each prediction can be represented by one dimension (e.g., longitudinal distance) or by two dimensions (e.g., longitudinal distance and lateral distance). As noted previously, the longitudinal and/or lateral distances described herein can be with respect to any reference frame, such as with respect to a Cartesian frame of reference (e.g., a Cartesian grid), a lane-centered Frenet frame, a road-centered Frenet frame, or other frame of reference. The prediction rasterization engine 510 is said to perform a rasterization of the prediction, which is essentially the prediction being discretized onto the path of the autonomous vehicle (e.g., ego vehicle).

In one or more examples, during operation of the prediction rasterization engine 510, the prediction rasterization engine 510 can subsample predictions at fixed time steps (e.g., where Δt=0.1 s). Each sampled prediction can be approximated (e.g., represented) by a set of (e.g., including one or more) symbols (e.g., circles, squares, triangle, polygons, or rectangles, such as shown in graphs 300, 350 of FIG. 3). In some cases, each symbol can encode information associated with a vehicle (e.g., encode an approximated shape of the vehicle) as the vehicle traverses a predicted trajectory. Each symbol can then be projected onto a localized corridor (e.g., straight path of graph 350 of FIG. 3) for the autonomous vehicle (e.g., ego vehicle).

Then, the traffic model initialization engine 520 can perform traffic model initialization, which can involve generating a “micro-traffic” model for all of the agent vehicles. In one or more examples, for traffic model initialization, cach participating traffic agent (e.g., each agent vehicle) can be assigned a reactivity model based on a traffic context (e.g., a “micro-traffic” context), which can include, but is not limited to, “leader-follower relationships” in traffic and/or “vehicles within a set of adjacent lanes” in traffic.

The agent reaction reconciliation engine 530 can then perform agent reaction reconciliation, which can involve understanding how the agent vehicles will react (e.g., determining the agent vehicles' reactions, which may include longitudinal reactions, such as acceleration and/or deceleration, and/or may include lateral reactions) to the autonomous vehicle as well as potentially to each other. The agent vehicles' reactions can be determined based on the position and dynamics of the autonomous vehicle (e.g., ego vehicle) and the reactivity models for the agent vehicles.

In one or more examples, for agent reaction reconciliation, for each simulated scene, object traffic models can be updated with respect to the autonomous vehicle (e.g., ego vehicle) position and dynamics as well as to the position and dynamics of the agent vehicles. These reactions can then be combined with the prediction priors, where appropriate, to give a vector of Frenet-aligned object regions.

Then, the scene propagation engine 540 can perform scene propagation by using the determined reactions. For scene propagation, the simulated scene (e.g., diagram 600 of FIG. 6) can be updated to produce a forward simulated scene (e.g., diagram 650 of FIG. 6) based on a reaction (e.g., which may include longitudinal reactions, such as acceleration and/or deceleration, and/or may include lateral reactions) of the autonomous vehicle (e.g., ego vehicle) and the reactions of the agent vehicles. In one or more examples, for scene propagation, given an autonomous vehicle (e.g., ego vehicle) reaction, the scene index can increment, and all the agent vehicles as well as the autonomous vehicle (e.g., ego vehicle) can take a step (e.g., a dynamic step) forward along the path.

In one or more aspects, the scene propagation engine 540 can operate as a simple simulator of dynamic objects (e.g., the ego vehicle and the agent vehicles) along their expected trajectories (e.g., prediction trajectories). In one or more examples, during operation of the scene propagation engine 540, the scene propagation engine 540 can operate by stepping the ego vehicle and the agent vehicles along their predicted trajectories over time, with steps for all the vehicles at time “t” being performed simultaneously. At every timestep (e.g., cach scene index), each of the vehicles can have an opportunity to apply a longitudinal reaction model (e.g., some examples may, alternatively, employ a longitudinal and lateral reaction model) to modulate each of the vehicle's longitudinal step along the vehicle's trajectory. As such, the vehicles can step along their prescribed paths in space (e.g., where their lateral component may be fixed), where their longitudinal dynamics (e.g., how far the vehicle steps, at what speed, acceleration, etc.) at each step is determined by their reaction models.

The Scene branching engine 550 can then perform scene branching from the scene. For scene branching, the forward simulated scene can be represented as a node in a tree for a tree search (e.g., MCTS). Branching of the forward simulated scene can be performed by using the tree search (e.g., MCTS). In one or more examples, for scene branching, for branches (e.g., nodes) in the tree (e.g., the MCTS tree), the autonomous vehicle (e.g., ego vehicle) dynamics and the reactivity state for all agent vehicles can be copied, while the rasterized predictions and other a priori quantities can remain fixed.

In one or more aspects, the scene branching engine 550 can encode traffic beliefs throughout the tree (e.g., the MCTS tree). Each node in the tree can represent a unique belief. In one or more examples, the prediction trajectories for the forward simulated scene can be encoded within a node (e.g., a root node, such as root node 450a of FIG. 4). In one or more examples, during operation of scene branching by the scene branching engine 550, the scene branching engine 550 can create a child node (e.g., node 450b of FIG. 4) in the tree off of a parent node (e.g., a root node, such as root node 450a of FIG. 4) in the tree. The scene branching engine 550 can create the child node by branching the traffic belief, applying a new ego vehicle action and corresponding object (e.g., vehicle) reactions, and caching the new belief at the child node. In one or more examples, the scene branching engine 550 can gather rewards (e.g., costs assigned to the longitudinal distance between the ego vehicle and the agent vehicles).

FIG. 6 illustrates the procedure performed by the system 500 of FIG. 5. In particular, FIG. 6 are diagrams 600, 650 that illustrate an example of forward simulation for traffic that includes an autonomous vehicle 610a, 610b (e.g., ego vehicle). In FIG. 6, the diagram 600 shows the original, discretized predictions for the autonomous vehicle 610a (e.g., ego vehicle) and the agent vehicles 620a, 630a, 640a (e.g., at time “t=0”). The region between the dashed lines in diagram 600 represents the localized Frenet corridor for the autonomous vehicle 610a (e.g., ego vehicle) action space. Lateral actions may be disallowed outside of this region, and vehicles located outside of this region are unknown to the simulator.

The diagram 650 in FIG. 6 shows the scene of diagram 600 after some time has elapsed (e.g., at time “t>0”). In diagram 650, all of the vehicles (e.g., the autonomous vehicle and the agent vehicles) have moved forward along their respective paths. The agent vehicles 620b, 630b, 640b may be only allowed to move along their prescribed paths, while the autonomous vehicle 610b (e.g., ego vehicle) may be free to move according to an arbitrary action space. After the scene is propagated, the micro-traffic models of the front two agent vehicles 630b, 640b can indicate that they should overtake the autonomous vehicle 610b (e.g., ego vehicle). In other words, the autonomous vehicle 610b (e.g., ego vehicle) should yield to these two agent vehicles 630b, 640b. In the diagram 650, each of these agent vehicles 630b, 640b is shown to be denoted with a letter “Y” to indicate that the autonomous vehicle 610b (e.g., ego vehicle) should yield to these agent vehicles 630b, 640b.

The other agent vehicle 620b, however, may be estimated to yield to the autonomous vehicle 610b (e.g., ego vehicle). As such, in diagram 650, the agent vehicle 620b is shown to be denoted with a letter “O” to indicate that the autonomous vehicle 610b (e.g., ego vehicle) should overtake the agent vehicle 620b. The model for this agent vehicle 620b, as shown in diagram 650, can suggest that the agent vehicle 620b should brake to allow the autonomous vehicle 610b (e.g., ego vehicle) to merge in. As such, the agent vehicle 620b can be modeled to deviate from its original predicted position, marked with a hashed box (e.g., shown as agent vehicle 620c). The reactionary “backoff distance” for the agent vehicle 620b, 620c is depicted in terms of its change in station, As. For this example of FIG. 6, a simulated scene can be completely defined with the following tuple: (t, sₑ, vₑ, αₑ, [symbol] ₚᵤᵣₚₗₑ, [symbol] _{blue}, [symbol] _{orange}), which can represent the scene time; the autonomous vehicle (e.g., ego vehicle) station, velocity, and acceleration; and the semantic directive (e.g., yield or overtake) for the three agent vehicles 620c, 630b, 640b. Branching the forward simulator within a tree solver like MCTS can therefore be very efficient.

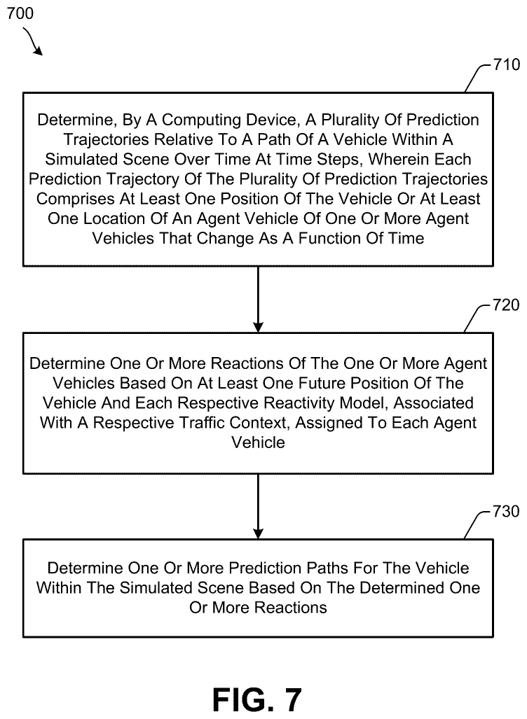

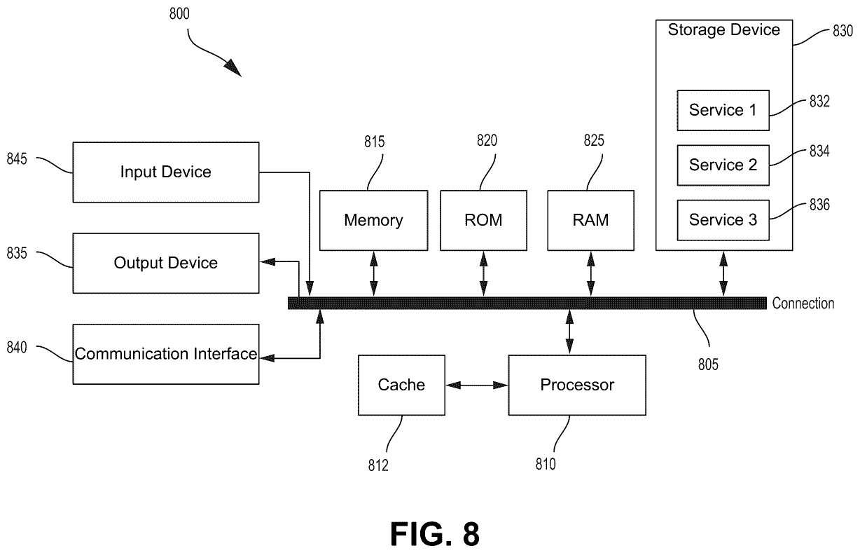

FIG. 7 is a flow chart illustrating an example of a process 700 for a lightweight forward simulation for decision-making. The process 700 can be performed by a computing device (e.g., an electronic device of a vehicle, such as an AV) or by a component or system (e.g., a chipset) of the device. The operations of the process 700 may be implemented as software components that are executed and run on one or more engines and/or processors (e.g., processor 810 of FIG. 8 or other processor(s)).

At block 710, the computing device (or component or system thereof), can determine a plurality of prediction trajectories relative to (e.g., onto or near) a path of a vehicle within a simulated scene over time at time steps. In one illustrative example, the path is a localized corridor. Each prediction trajectory of the plurality of prediction trajectories can include at least one location of an agent vehicle of one or more agent vehicles. In some cases, each prediction trajectory of the plurality of prediction trajectories further includes at least one position of the vehicle. The at least one position of the vehicle and the at least one location of the agent vehicle change over time. For instance, a predicted trajectory can be multiple future positions that change over time. In some aspects, each prediction trajectory of the plurality of prediction trajectories is represented by one dimension (e.g., a longitudinal distance) or two dimensions (e.g., a longitudinal distance and a lateral distance). The longitudinal distance and/or lateral distances can be with respect to any reference frame, such as a Cartesian frame of reference (e.g., a Cartesian grid), a lane-centered Frenet frame, a road-centered Frenet frame, or other frame of reference. Additionally or alternatively, in some cases, each prediction trajectory of the plurality of prediction trajectories is represented within the simulated scene by one or more symbols (e.g., a circle, a square, a rectangle, a triangle, a polygon, etc.). In some cases, each symbol can encode information associated with a vehicle as the vehicle traverses a prediction trajectory. For instance, a symbol (e.g., a circle, square, etc.) can encode an approximated shape of the vehicle as the vehicle traverses the prediction trajectory.

At block 720, the computing device (or component or system thereof), can determine one or more reactions of the one or more agent vehicles based on at least one future position of the vehicle and each respective reactivity model assigned to each agent vehicle. As described herein, each respective reactivity model is associated with a respective traffic context. For example, a respective reactivity model can be based on a traffic context. In some cases, the traffic context can be based on at least one of leader-follower relationships in traffic or vehicles-within-a-set-of-adjacent-lanes in the traffic. In some aspects, the one or more reactions of the one or more agent vehicles includes one or more longitudinal reactions and/or one or more lateral reactions. For instance, the one or more longitudinal reactions can include accelerating and/or decelerating.

At block 730, the computing device (or component or system thereof), can determine one or more prediction paths for the vehicle within the simulated scene based on the determined one or more reactions.

In some aspects, the computing device (or component or system thereof) can update the simulated scene to produce a forward simulated scene based on a reaction of the vehicle and the one or more reactions of the one or more agent vehicles. In some cases, to update the simulated scene to produce a forward simulated scene, the computing device (or component or system thereof) can modulate each step of the vehicle and the one or more agent vehicles based on the reaction of the vehicle and the one or more reactions of the one or more agent vehicles. In some cases, the computing device (or component or system thereof) can modulate each step of the vehicle and the one or more agent vehicles at each scene index. In some examples, the computing device (or component or system thereof) can perform branching of the forward simulated scene using a tree search (e.g., a Monte Carlo Tree Search (MCTS) or other type of tree search). In some cases, the forward simulated scene is represented as a node within a tree for the tree search. For example, the plurality of prediction trajectories for the forward simulated scene can be encoded within the node within the tree.

The computing device (e.g., electronic device) may include various components, such as one or more input devices, one or more output devices, one or more processors, one or more microprocessors, one or more microcomputers, one or more cameras, one or more sensors, one or more receivers, transmitters, and/or transceivers, and/or other component(s) that are configured to carry out the steps of processes described herein.

The components of the device configured to perform the process 700 of FIG. 7 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 700 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the process.

Additionally, the process 700 and/or other processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 is a block diagram illustrating an example of a computing system 800, which may be employed by the disclosed systems and techniques for a lightweight forward simulation for decision-making. In particular, FIG. 8 illustrates an example of computing system 800, which can be, for example, any computing device making up internal computing system, a remote computing system, a camera, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some aspects, computing system 800 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 800 includes at least one processing unit (CPU or processor) 810 and connection 805 that communicatively couples various system components including system memory 815, such as read-only memory (ROM) 820 and random access memory (RAM) 825 to processor 810. Computing system 800 can include a cache 812 of high-speed memory connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms. In some instances, multimodal systems can enable a user to provide multiple types of input/output to communicate with computing system 800.

Computing system 800 can include communications interface 840, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 840 may also include one or more range sensors (e.g., LIDAR sensors, laser range finders, RF radars, ultrasonic sensors, and infrared (IR) sensors) configured to collect data and provide measurements to processor 810, whereby processor 810 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), crasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, it causes the system to perform a function. In some aspects, a hardware service that performs a particular function can include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thercon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for cach particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically crasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative aspects of the disclosure include:

Aspect 1: A method for decision making for operation of at least one vehicle, the method comprising: determining, by a computing device, a plurality of prediction trajectories relative to a path of a vehicle within a simulated scene over time at time steps, wherein each prediction trajectory of the plurality of prediction trajectories comprises at least one location of an agent vehicle of one or more agent vehicles as a function of time; determining, by the computing device, one or more reactions of the one or more agent vehicles based on at least one future position of the vehicle and each respective reactivity model, associated with a respective traffic context, assigned to each agent vehicle; and determining, by the computing device, one or more prediction paths for the vehicle within the simulated scene based on the determined one or more reactions.

Aspect 2: The method of claim 1, wherein each prediction trajectory of the plurality of prediction trajectories is represented by one of one dimension or two dimensions.

Aspect 3: The method of claim 2, wherein the one dimension is longitudinal distance.

Aspect 4: The method of claim 2, wherein the two dimensions are longitudinal distance and lateral distance.

Aspect 5: The method of any one of claims 1 to 4, wherein each prediction trajectory of the plurality of prediction trajectories is represented within the simulated scene by one or more symbols.

Aspect 6: The method of claim 5, wherein the one or more symbols are each one of a circle, a square, a rectangle, a triangle, or a polygon.

Aspect 7: The method of any one of claims 1 to 6, wherein the path is a localized corridor.

Aspect 8: The method of any one of claims 1 to 7, wherein the traffic context is based on at least one of leader-follower relationships in traffic or vehicles-within-a-set-of-adjacent-lanes in the traffic.

Aspect 9: The method of any one of claims 1 to 8, wherein the one or more reactions of the one or more agent vehicles comprises at least one of one or more longitudinal reactions or one or more lateral reactions.

Aspect 10: The method of claim 9, wherein the one or more longitudinal reactions comprises at least one of accelerating or decelerating.

Aspect 11: The method of any one of claims 1 to 10, further comprising updating, by the computing device, the simulated scene to produce a forward simulated scene based on a reaction of the vehicle and the one or more reactions of the one or more agent vehicles.

Aspect 12: The method of claim 11, wherein updating, by the computing device, the simulated scene to produce a forward simulated scene comprises modulating each step of the vehicle and the one or more agent vehicles based on the reaction of the vehicle and the one or more reactions of the one or more agent vehicles.

Aspect 13: The method of claim 12, wherein modulating of each step of the vehicle and the one or more agent vehicles is performed at each scene index.

Aspect 14: The method of any one of claims 11 to 13, further comprising performing, by the computing device, branching of the forward simulated scene using a tree search.

Aspect 15: The method of claim 14, wherein the forward simulated scene is represented as a node within a tree for the tree search.

Aspect 16: The method of claim 15, wherein the plurality of prediction trajectories for the forward simulated scene are encoded within the node within the tree.

Aspect 17: The method of any one of claims 14 to 16, wherein the tree search is a Monte Carlo Tree Search (MCTS).

Aspect 18: The method of any one of claims 1 to 17, further comprising assigning, by the computing device, costs to each respective distance between the vehicle and the one or more agent vehicles.

Aspect 19: An apparatus for decision making for operation of at least one vehicle, the apparatus comprising: at least one memory; and at least one processor coupled to the at least one memory and configured to: determine a plurality of prediction trajectories relative to a path of a vehicle within a simulated scene over time at time steps, wherein each prediction trajectory of the plurality of prediction trajectories comprises at least one location of an agent vehicle of one or more agent vehicles as a function of time; determine one or more reactions of the one or more agent vehicles based on at least one future position of the vehicle and each respective reactivity model, associated with a respective traffic context, assigned to each agent vehicle; and determine one or more prediction paths for the vehicle within the simulated scene based on the determined one or more reactions.

Aspect 20: The apparatus of claim 19, wherein each prediction trajectory of the plurality of prediction trajectories is represented by one of one dimension or two dimensions.

Aspect 21: The apparatus of claim 20, wherein the one dimension is longitudinal distance.

Aspect 22: The apparatus of claim 20, wherein the two dimensions are longitudinal distance and lateral distance.

Aspect 23: The apparatus of any one of claims 19 to 22, wherein each prediction trajectory of the plurality of prediction trajectories is represented within the simulated scene by one or more symbols.

Aspect 24: The apparatus of claim 23, wherein the one or more symbols are each one of a circle, a square, a rectangle, a triangle, or a polygon.

Aspect 25: The apparatus of any one of claims 19 to 24, wherein the path is a localized corridor.

Aspect 26: The apparatus of any one of claims 19 to 25, wherein the traffic context is based on at least one of leader-follower relationships in traffic or vehicles-within-a-set-of-adjacent-lanes in the traffic.

Aspect 27: The apparatus of any one of claims 19 to 26, wherein the one or more reactions of the one or more agent vehicles comprises at least one of one or more longitudinal reactions or one or more lateral reactions.

Aspect 28: The apparatus of claim 27, wherein the one or more longitudinal reactions comprises at least one of accelerating or decelerating.

Aspect 29: The apparatus of any one of claims 19 to 28, wherein the at least one processor is configured to update the simulated scene to produce a forward simulated scene based on a reaction of the vehicle and the one or more reactions of the one or more agent vehicles.

Aspect 30: The apparatus of claim 29, wherein, to update the simulated scene to produce a forward simulated scene, the at least one processor is configured to modulate each step of the vehicle and the one or more agent vehicles based on the reaction of the vehicle and the one or more reactions of the one or more agent vehicles.

Aspect 31: The apparatus of claim 30, wherein the at least one processor is configured to modulate each step of the vehicle and the one or more agent vehicles at each scene index.

Aspect 32: The apparatus of any one of claims 29 to 31, wherein the at least one processor is configured to perform branching of the forward simulated scene using a tree search.

Aspect 33: The apparatus of claim 32, wherein the forward simulated scene is represented as a node within a tree for the tree search.

Aspect 34: The apparatus of claim 33, wherein the plurality of prediction trajectories for the forward simulated scene are encoded within the node within the tree.

Aspect 35: The apparatus of any one of claims 32 to 34, wherein the tree search is a Monte Carlo Tree Search (MCTS).

Aspect 36: The apparatus of any one of claims 19 to 35, wherein the at least one processor is configured to assign costs to each respective distance between the vehicle and the one or more agent vehicles.

Aspect 37: A non-transitory computer-readable medium comprising instructions that, when executed by at least one processor, cause the at least one processor to perform operations according to any of claims 1 to 18.

Aspect 38: An apparatus comprising one or more means for performing operations according to any of claims 1 to 18.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for decision making for operation of at least one vehicle, the apparatus comprising:
at least one memory; and
at least one processor coupled to the at least one memory and configured to:
determine a plurality of prediction trajectories relative to a path of a vehicle within a simulated scene over time at time steps, wherein each prediction trajectory of the plurality of prediction trajectories comprises at least one location of an agent vehicle of one or more agent vehicles that change as a function of time;
determine one or more reactions of the one or more agent vehicles based on at least one future position of the vehicle and each respective reactivity model, associated with a respective traffic context, assigned to each agent vehicle; and
determine one or more prediction paths for the vehicle within the simulated scene based on the determined one or more reactions.

2. The apparatus of claim 1, wherein each prediction trajectory of the plurality of prediction trajectories is represented by one of one dimension or two dimensions.

3. The apparatus of claim 2, wherein the one dimension is longitudinal distance.

4. The apparatus of claim 2, wherein the two dimensions are longitudinal distance and lateral distance.

5. The apparatus of claim 1, wherein each prediction trajectory of the plurality of prediction trajectories is represented within the simulated scene by one or more symbols.

6. The apparatus of claim 5, wherein the one or more symbols are each one of a circle, a square, a rectangle, a triangle, or a polygon.

7. The apparatus of claim 1, wherein the path is a localized corridor.

8. The apparatus of claim 1, wherein a traffic context is based on at least one of leader-follower relationships in traffic or vehicles-within-a-set-of-adjacent-lanes in the traffic.

9. The apparatus of claim 1, wherein the one or more reactions of the one or more agent vehicles comprises at least one of one or more longitudinal reactions or one or more lateral reactions.

10. The apparatus of claim 9, wherein the one or more longitudinal reactions comprises at least one of accelerating or decelerating.

11. The apparatus of claim 1, wherein the at least one processor is configured to update the simulated scene to produce a forward simulated scene based on a reaction of the vehicle and the one or more reactions of the one or more agent vehicles.

12. The apparatus of claim 11, wherein, to update the simulated scene to produce a forward simulated scene, the at least one processor is configured to modulate each step of the vehicle and the one or more agent vehicles based on the reaction of the vehicle and the one or more reactions of the one or more agent vehicles.

13. The apparatus of claim 12, wherein the at least one processor is configured to modulate each step of the vehicle and the one or more agent vehicles at each scene index.

14. The apparatus of claim 11, wherein the at least one processor is configured to perform branching of the forward simulated scene using a tree search.

15. The apparatus of claim 14, wherein the forward simulated scene is represented as a node within a tree for the tree search.

16. The apparatus of claim 15, wherein the plurality of prediction trajectories for the forward simulated scene are encoded within the node within the tree.

17. The apparatus of claim 14, wherein the tree search is a Monte Carlo Tree Search (MCTS).

18. The apparatus of claim 1, wherein the at least one processor is configured to assign costs to each respective distance between the vehicle and the one or more agent vehicles.

19. The apparatus of claim 1, wherein each prediction trajectory of the plurality of prediction trajectories further comprises at least one position of the vehicle.

20. A method for decision making for operation of at least one vehicle, the method comprising:
determining, by a computing device, a plurality of prediction trajectories relative to a path of a vehicle within a simulated scene over time at time steps, wherein each prediction trajectory of the plurality of prediction trajectories comprises at least one location of an agent vehicle of one or more agent vehicles that change as a function of time;
determining, by the computing device, one or more reactions of the one or more agent vehicles based on at least one future position of the vehicle and each respective reactivity model, associated with a respective traffic context, assigned to each agent vehicle; and
determining, by the computing device, one or more prediction paths for the vehicle within the simulated scene based on the determined one or more reactions.

21. The method of claim 20, wherein each prediction trajectory of the plurality of prediction trajectories is represented by one of one dimension or two dimensions.

22. The method of claim 20, wherein each prediction trajectory of the plurality of prediction trajectories is represented within the simulated scene by one or more symbols.

23. The method of claim 20, wherein the one or more reactions of the one or more agent vehicles comprises at least one of one or more longitudinal reactions or one or more lateral reactions.

24. The method of claim 20, further comprising updating, by the computing device, the simulated scene to produce a forward simulated scene based on a reaction of the vehicle and the one or more reactions of the one or more agent vehicles.

25. The method of claim 24, wherein updating, by the computing device, the simulated scene to produce a forward simulated scene comprises modulating each step of the vehicle and the one or more agent vehicles based on the reaction of the vehicle and the one or more reactions of the one or more agent vehicles.

26. The method of claim 25, wherein modulating of each step of the vehicle and the one or more agent vehicles is performed at each scene index.

27. The method of claim 24, further comprising performing, by the computing device, branching of the forward simulated scene using a tree search.

28. The method of claim 27, wherein the forward simulated scene is represented as a node within a tree for the tree search, and wherein the plurality of prediction trajectories for the forward simulated scene are encoded within the node within the tree.

29. The method of claim 20, further comprising assigning, by the computing device, costs to each respective distance between the vehicle and the one or more agent vehicles.

30. The method of claim 20, wherein each prediction trajectory of the plurality of prediction trajectories further comprises at least one position of the vehicle.
